(19) United States
(12) Patent Application Publication
(10) Pub. No.: US 2026/0154747 A1
(43) Pub. Date: Jun. 4, 2026

(54) SYSTEMS AND METHOD FOR AUTOMATED CURATION OF MULTIMEDIA COMPOSITIONS AND GENERATION OF COLLABORATIVE DIGITAL ASSETS

(71) Applicants: Yaniv TARAGAN, Modi'in (IL); Netanel LEV ARI, Modi'in (IL); Sean LEV ARI, Modi'in (IL); Netanel GISPAN, Jerusalem (IL); Daniel YERONDIS, Ramat Gan (IL); Nerya DAYI, Karmei Katif (IL)

(72) Inventors: Yaniv TARAGAN, Modi'in (IL); Netanel LEV ARI, Modi'in (IL); Sean LEV ARI, Modi'in (IL); Netanel GISPAN, Jerusalem (IL); Daniel YERONDIS, Ramat Gan (IL); Nerya DAYI, Karmei Katif (IL)

(21) Appl. No.: 19/306,059

(22) Filed: Aug. 21, 2025

(30) Foreign Application Priority Data
Dec. 4, 2024 (IL) 317471

(51) Int. Cl. G06Q 40/04; G06Q 20/36; G06V 40/16

(52) U.S. Cl. CPC G06Q 40/055; G06Q 20/36; G06V 40/172

(57) ABSTRACT

A system and method for generating a unified multimedia composition from a plurality of multimedia content items received from heterogeneous, independently operating devices is disclosed. For each item, a composite contextual metadata record including at least spatial and temporal data is generated. An automated curation process applies at least one programmatic selection rule based on the metadata to identify a target subset of the content items. The system then algorithmically aligns and compiles the target subset into the unified multimedia output. The invention further provides a method for generating a digital asset from the collaborative composition by minting a non-fungible token (NFT) cryptographically linked to the composite video and programmatically distributing ownership shares of the NFT to the digital wallets of users who contributed content. In some embodiments, ownership shares are also programmatically allocated to individuals depicted in the video, identified via facial recognition. The methods are applicable across various fields including security monitoring, insurance claim verification, and collaborative media production.

### RELATED APPLICATIONS

This application claims the benefit of priority of Israel Patent Application No. 317471 filed 4 Dec. 2024, the contents of which are incorporated herein by reference in their entirety.

### FIELD OF THE INVENTION

The present invention relates generally to the field of multimedia content management. More specifically, it pertains to systems and methods for automatically curating a unified multimedia composition from a plurality of content items captured by heterogeneous devices by applying programmatic selection rules based on spatial, temporal, and semantic metadata. The invention further relates to methods for generating a digital asset, such as a non-fungible token (NFT), representing the collaborative composition and programmatically distributing ownership shares to its contributors.

### BACKGROUND OF THE INVENTION

The modern digital landscape is characterized by an unprecedented volume of multimedia content captured from a heterogeneous array of sources. Devices ranging from user-operated smartphones and drones to automated security cameras and vehicle-mounted dash cameras continuously generate vast streams of video, audio, and photographic data. While this proliferation of capture devices offers the potential for comprehensive, multi-perspective documentation of any given event, the technical challenge of integrating these disparate, uncoordinated data streams into a single, cohesive narrative remains significant. The sheer scale of the data makes manual consolidation and editing computationally inefficient, prohibitively expensive, and impractical for real-time or near-real-time applications.

Conventional approaches in the art for managing multi-source media have focused primarily on synchronization and providing tools to assist a human editor. Known systems often allow for the creation of multi-camera videos by synchronizing streams based on common audio cues or timestamps. These systems typically present the aligned streams in an interface where a user can manually review the footage and select the desired camera angles to create a final composition. While useful for post-production environments, such systems still rely entirely on a human operator to perform the crucial curation step of selecting which content is relevant or compelling. This manual bottleneck does not scale to handle the dynamic influx of content from dozens or hundreds of independent devices and fails to leverage the rich contextual data embedded within each media item.

More recent developments have explored a degree of automation in content generation. Some existing systems are capable of automatically creating a media presentation by grouping content based on simple metadata like time and location. These systems, however, are often designed to work with a self-contained set of media, such as a single user's photo library or content from a pre-defined group. They generally lack a sophisticated framework for applying dynamic, programmatic selection rules to intelligently curate a target subset of content in real-time from a massive, open-ended pool of heterogeneous sources. A significant technical gap remains in providing an intelligent, automated curation process that can filter, select, and align content based not only on spatial and temporal metadata but also on semantic attributes derived from the content itself, such as the presence of specific individuals or detected levels of activity.

Parallel to the challenges in content curation, the rise of collaborative creation has introduced complex issues related to intellectual property and ownership. When a final work is composed of contributions from numerous independent creators, traditional frameworks for assigning and managing ownership rights are inadequate and cumbersome. The emergence of blockchain technology and non-fungible tokens (NFTs) offers a new paradigm for digital asset management. While the prior art describes methods for creating and managing individual digital assets as NFTs, these systems do not address the specific challenge of programmatically and automatically distributing ownership shares of a newly created composite work to its many contributors. This includes not just the photographers but also the subjects depicted, with ownership allocated based on their specific, verifiable contributions.

Therefore, there is a long-felt need for a comprehensive solution that overcomes these distinct but related challenges. A need exists for a system that can move beyond manual editing and simple automation to provide an intelligent, automated curation process for multimedia content from heterogeneous sources, driven by configurable, programmatic rules based on rich contextual metadata. Furthermore, there is a corresponding need for a transparent and automated mechanism to manage the resulting collaborative work as a digital asset, programmatically attributing and distributing ownership to all participants in a verifiable and equitable manner.

### SUMMARY OF THE INVENTION

The present invention provides systems and methods for automatically generating a unified multimedia composition from a plurality of disparate sources and for managing the ownership of the resulting collaborative work as a digital asset. The invention overcomes the limitations of manual editing and simple synchronization by implementing an intelligent, rule-based curation process.

In one aspect, the present invention provides a method for generating a multimedia composition. The method begins by receiving a plurality of multimedia content items from a heterogeneous set of independently operating devices, which can include user-operated mobile devices as well as automated devices like security or dash cameras. For each of these content items, the system generates a composite contextual metadata record that includes at least spatial coordinates and a temporal stamp. An automated curation process is then executed on the plurality of content items and their associated metadata. This process applies at least one programmatic selection rule to intelligently identify a target subset of the content items. These rules can be based on parameters such as a spatial attribute, a temporal attribute, a capture parameter like field of view, or a semantic attribute derived from the content itself. Once the target subset is identified, the system algorithmically determines a spatial and temporal alignment for the selected items and composes a single, unified multimedia output by compiling and rendering them according to the applied rule.

In further embodiments, the programmatic selection rules can be configured for specific applications. For example, a rule may be triggered in response to a distress alert, automatically compiling relevant footage from nearby devices to provide situational awareness for an Event Manager. Other applications include automated compilation for security monitoring based on a real-time event detection alert, for insurance claim verification by comparing captured content with predefined event data, or for documenting medical procedures from multiple camera feeds for remote professional review. The system may further utilize machine learning algorithms to detect and correct for misalignment in the content and can store all original content and metadata for subsequent reprocessing with different selection rules.

In another aspect, the invention provides a method for generating and distributing ownership of a digital asset representing the collaborative work created by the foregoing method. This involves generating a composite multimedia video and then minting a non-fungible token (NFT) that is cryptographically linked to it, serving as a verifiable record of ownership on a blockchain. In a key feature of the invention, ownership shares of the newly minted NFT are programmatically and automatically distributed to the digital wallets of each user who contributed a multimedia content item that was included in the final composite video.

The distribution of these ownership shares can be determined by a configurable function, such as an equal distribution or a distribution proportional to the amount of each user's content used in the final video. In a particularly novel embodiment, the system may apply a facial recognition algorithm to the composite video to identify individuals depicted therein and programmatically allocate a percentage of ownership in the NFT to those identified subjects, thereby rewarding both the creators and the participants. The system may further provide a marketplace interface for transacting the NFT and may include a smart contract mechanism to allow for the retroactive claiming of ownership shares.

In one aspect of the invention, a method of generating a multimedia composition, the method comprising:
a. receiving a plurality of multimedia content items from a heterogeneous set of independently operating devices;
b. for each of the plurality of multimedia content items, generating a composite contextual metadata record, said record comprising at least spatial coordinates and a temporal stamp;
c. executing an automated curation process on the plurality of content items and their associated composite contextual metadata records, said process comprising:
   i. applying at least one programmatic selection rule to identify a target subset of the content items, wherein said rule is based on parameters selected from the group consisting of a spatial attribute, a temporal attribute, and a capture parameter; and
   ii. algorithmically determining a spatial and temporal alignment for the identified target subset; and
   iii. composing a single, unified multimedia output by compiling and rendering the aligned target subset according to the applied programmatic selection rule.

In another aspect of the invention, the method above is provided, wherein the composite contextual metadata record further comprises a content-derived feature vector, and wherein the programmatic selection rule is further based on a semantic attribute specified in the content-derived feature vector.

In another aspect of the invention, the method as defined in any of above is provided, wherein the semantic attribute comprises a designated focal point, a specified quantity of detected objects or persons, or a detected level of user activity, and wherein the capture parameter is selected from the group consisting of a field of view and an aspect ratio.

In another aspect of the invention, the method as defined in any of above is provided, wherein the heterogeneous set of independently operating devices includes at least one user-operated mobile device and at least one automated device selected from the group consisting of a security camera, a dash camera, and a wearable camera.

In another aspect of the invention, the method as defined in any of above is provided, wherein the temporal attribute of the programmatic selection rule defines a time-limited capture window, and wherein the curation process is configured to operate in at least one of two modes: a synchronized mode wherein capture is initiated simultaneously via a trigger signal, or an asynchronous mode wherein content items captured at any point within the window are eligible for selection; and wherein the programmatic selection rule is further defined by a specified ordering logic comprising a sequential concatenation, a random selection, or an arrangement based on a defined timeline or geoline.

In another aspect of the invention, the method as defined in any of above is provided, wherein the programmatic selection rule is configured to identify and compile content in response to a distress alert initiated by a first user device, the method further comprising providing an interface for a designated Event Manager to view multiple content items from the target subset simultaneously.

In another aspect of the invention, the method as defined in any of above is provided, further comprising applying a machine learning algorithm to detect and correct for misalignment in the identified target subset.

In another aspect of the invention, the method as defined in any of above is provided, further comprising storing the composite contextual metadata records and the multimedia content items in a storage subsystem for subsequent reprocessing using a different programmatic selection rule.

In one aspect of the invention, a method for generating and distributing ownership of a digital asset representing a collaborative work, the method comprising:
a. generating a composite multimedia video by receiving a plurality of multimedia content items from a heterogeneous set of devices, generating a
composite contextual metadata record for each item, and executing an automated curation process to compose a unified multimedia output based on a programmatic selection rule;
b. minting, by at least one processor, a non-fungible token (NFT) cryptographically linked to the composite multimedia video, said NFT representing a verifiable record of ownership; and
c. programmatically distributing, by the at least one processor, ownership shares of the NFT to a digital wallet of each user who contributed a multimedia content item that was included in the composite multimedia video.

In another aspect of the invention, the method above is provided, wherein the distribution of ownership shares is determined by a configurable function selected from the group consisting of an equal distribution among all contributing users and a distribution proportional to a percentage of time each user's content item is used in the composite multimedia video.

In another aspect of the invention, the method as defined in any of above is provided, further comprising:
a. applying a facial recognition algorithm to the composite multimedia video to identify one or more individuals depicted therein; and
b. programmatically allocating a percentage of ownership in the NFT to a digital wallet of at least one of the identified individuals.

In another aspect of the invention, the method as defined in any of above is provided, further comprising providing a marketplace interface configured to facilitate a transaction involving the NFT, said transaction comprising at least one of a sale, an auction, or a license grant.

In another aspect of the invention, the method as defined in any of above is provided, further comprising enabling, via a smart contract associated with the NFT, a retroactive claim of an ownership share by a contributing user who did not possess a digital wallet at the time of the distribution.

In one aspect of the invention, a system for generating a multimedia composition, the system comprising:
a. at least one processor; and
b. a non-transitory computer-readable storage medium storing instructions that, when executed by the at least one processor, cause the system to perform operations comprising:
   i. receiving a plurality of multimedia content items from a heterogeneous set of independently operating devices;
   ii. for each of the plurality of multimedia content items, generating a composite contextual metadata record, said record comprising at least spatial coordinates and a temporal stamp; and
   iii. executing an automated curation process on the plurality of content items and their associated composite contextual metadata records by:
      1) applying at least one programmatic selection rule to identify a target subset of the content items, wherein said rule is based on parameters selected from the group consisting of a spatial attribute, a temporal attribute, and a capture parameter;
      2) algorithmically determining a spatial and temporal alignment for the identified target subset; and
      3) composing a single, unified multimedia output by compiling and rendering the aligned target subset according to the applied programmatic selection rule.

In another aspect of the invention, the system above is provided, wherein the composite contextual metadata record further comprises a content-derived feature vector, and wherein the programmatic selection rule is further based on a semantic attribute specified in the content-derived feature vector, said semantic attribute comprising a designated focal point, a specified quantity of detected objects or persons, or a detected level of user activity.

In another aspect of the invention, the system as defined in any of above is provided, wherein the programmatic selection rule is configured to identify and compile content in response to a distress alert initiated by a first user device, and wherein the operations further comprise providing an interface for a designated Event Manager to view multiple content items from the target subset simultaneously.

In another aspect of the invention, the system as defined in any of above is provided, wherein the programmatic selection rule is further defined by a specified ordering logic comprising a sequential concatenation, a random selection, or an arrangement based on a defined timeline or geoline.

In another aspect of the invention, the system as defined in any of above is provided, wherein the operations further comprise minting a non-fungible token (NFT) cryptographically linked to the unified multimedia output and programmatically distributing ownership shares of the NFT.

In another aspect of the invention, the system as defined in any of above is provided, wherein the operations further comprise applying a facial recognition algorithm to the unified multimedia output to identify one or more individuals depicted therein, and programmatically allocating a percentage of ownership in the NFT to a digital wallet of at least one of the identified individuals.

In one aspect of the invention, a non-transitory computer-readable storage medium storing instructions that, when executed by at least one processor of a computing device, cause the computing device to perform the method of claim 1.

### BRIEF DESCRIPTION OF THE DRAWINGS

The present invention will be better understood in view of the following figures in which:

FIG. 1 shows a simplified high-level diagram illustrating therein the system architecture for receiving and processing multimedia content from heterogeneous devices, in accordance with an embodiment of the present disclosure.

FIG. 2 shows a flowchart illustrating therein the method steps of the core automated curation process, including applying programmatic rules and composing a unified output, in accordance with an embodiment of the present disclosure.

FIG. 3 shows a flowchart illustrating therein the method steps for generating a non-fungible token (NFT) from a composite video and programmatically distributing ownership shares, in accordance with an embodiment of the present disclosure.

FIG. 4 shows a simplified diagram of a user interface screen for defining parameters of a programmatic selection rule, in accordance with an embodiment of the present disclosure.

FIG. 5 shows a simplified diagram of a user interface for an Event Manager viewing multiple, synchronized content streams during a coordinated response event, in accordance with an embodiment of the present disclosure.

FIG. 6 shows a simplified diagram of a user interface screen illustrating the configuration of synchronized and asynchronous capture modes, in accordance with an embodiment of the present disclosure.

FIG. 7 shows a simplified high-level diagram illustrating therein a healthcare embodiment of the system for consolidating multimedia content during a surgical procedure for remote review, in accordance with an embodiment of the present disclosure.

FIG. 8 shows a simplified high-level diagram illustrating therein a security and emergency response embodiment of the system for compiling content from multiple sources in response to an event, in accordance with an embodiment of the present disclosure.

FIG. 9 shows a simplified high-level diagram illustrating therein an insurance embodiment of the system for integrating multimedia content to facilitate the verification of insurance claims, in accordance with an embodiment of the present disclosure.

FIG. 10 shows a conceptual diagram illustrating therein the programmatic distribution of non-fungible token (NFT) ownership shares to both content contributors and identified subjects, in accordance with an embodiment of the present disclosure.

FIG. 11 shows a block diagram of an exemplary system including a general-purpose computing device upon which the methods of the present disclosure may be implemented, in accordance with an embodiment of the present disclosure.

### DETAILED DESCRIPTION OF THE PREFERRED EMBODIMENTS

For the purposes of promoting an understanding of the principles of the invention, reference will now be made to the embodiments illustrated in the figures and specific language will be used to describe the same. While examples and features of disclosed principles are described herein, modifications, adaptations, and other implementations are possible without limitation of the scope of the disclosed embodiments. Any further applications of the principles described herein are contemplated as normally occur to one skilled in the art.

This disclosure employs open-ended permissive language, indicating for example, that some embodiments “may” employ, involve, or include specific features. The use of the term “may”, and other open-ended terminology is intended to indicate that although not every embodiment may employ the specific disclosed feature, at least one embodiment employs the specific disclosed feature.

In the following description, it is to be understood that the present disclosure may be practiced without one or more of the following details. Reference will now be made in detail to non-limiting examples of this disclosure, examples of which are illustrated in the accompanying figures. The examples are described below by referring to the figures, wherein like reference numerals refer to like elements. When similar reference numerals are shown, corresponding description(s) are not repeated, and the interested reader is referred to the previously discussed figure(s) for a description of the like element(s).

Various embodiments are described herein with reference to a system(s) and method(s). It is intended that the disclosure of one is a disclosure of all. For example, it is to be understood that disclosure of a system described herein also constitutes a disclosure of the method implemented by the system, via, for example, one or more processors. It is to be understood that this form of disclosure is for ease of discussion only, and one or more aspects of one embodiment herein may be combined with one or more aspects of other embodiments herein, within the intended scope of this disclosure.

The present disclosure provides a robust and scalable system and method for automatically curating multimedia compositions from a plurality of disparate sources and for managing the ownership of the resulting collaborative work as a digital asset. The invention provides a technical solution to the computational and logistical challenges of managing and synthesizing massive volumes of uncoordinated multimedia data. While the invention may be implemented in various forms, including as a standalone processing system for enterprise applications or as an integrated service for existing platforms, one preferred embodiment is a comprehensive social media application designed to facilitate and enhance collaborative content creation and sharing. The principles and processes described herein are foundational and can be adapted to numerous specific implementations.

### System Architecture and Overview

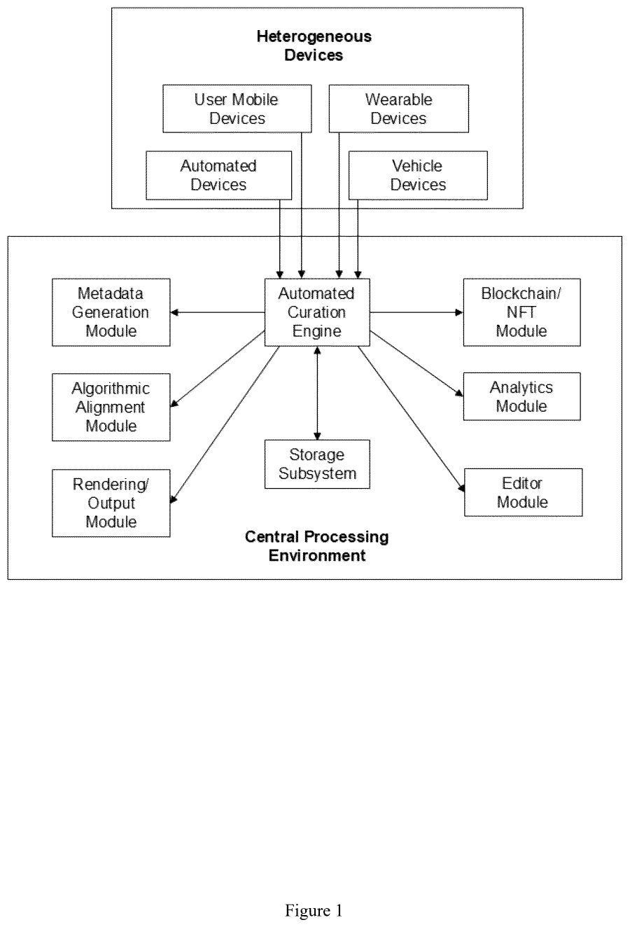

Referring to FIG. 1, a high-level diagram of the system architecture is shown, in accordance with an embodiment of the present disclosure. The system is designed to interface with and process a plurality of multimedia content items originating from a heterogeneous set of independently operating devices. These devices, which may include user-operated mobile devices, fixed security cameras, wearable body cameras, vehicle dash cameras, and other sources, transmit their captured content to a central processing environment. At the core of this environment is an automated curation engine, also referred to as a processing engine, which is configured to execute the novel methods of the present invention. This engine is in communication with several key modules, including a metadata generation module, a storage subsystem for archiving raw content and metadata, an algorithmic alignment module, a rendering or output module, and modules for managing the content as digital assets using blockchain technology. The system may also include an analytics module for evaluating content engagement and an editor module for optional manual or hybrid refinement of the automatically generated compositions.

### Multimedia Ingestion and Composite Contextual Metadata Generation

The process of generating a multimedia composition begins when the system receives a plurality of multimedia content items. A fundamental aspect of the invention is its ability to ingest and process content from a heterogeneous set of independently operating devices. This heterogeneity is a key technical challenge that the invention overcomes. The set of devices may include, without limitation, user-operated mobile devices such as smartphones and tablets running a dedicated application; and automated or semi-automated devices such as IP-based security cameras, vehicle-mounted dash cameras, and body-worn or other wearable cameras (e.g., smart glasses). In other embodiments, the system may also ingest content from specialized devices such as endoscopes and surgical cameras in a medical context, or even cameras mounted on animals or drones for unique perspectives. The system is configured with an input interface capable of receiving these varied content items, which can include video streams, audio recordings, and photographic data, via a plurality of communication protocols, including but not limited to Wi-Fi, Bluetooth, NFC, 5G/LTE cellular networks, Zigbee, and other wireless standards suitable for real-time or batch data transmission.

Upon receipt, or concurrent with receipt, of each multimedia content item, the system generates a composite contextual metadata record for that item. This rich metadata record is foundational to the subsequent automated curation process, providing the necessary context for the system's programmatic rules. At a minimum, this record comprises spatial coordinates, such as GPS latitude and longitude data, and a temporal stamp, such as a Universal Time Coordinated (UTC) timestamp, to precisely situate the content in space and time. In further embodiments, this metadata record may be substantially augmented to include a content-derived feature vector. This vector is generated by a processing module that applies machine learning (ML) or artificial intelligence (AI) algorithms to analyze the content itself. For example, computer vision algorithms can be used to extract semantic information such as the number of people or objects detected, the classification of the scene (e.g., indoor, outdoor, cityscape), the detection of specific landmarks, or the measurement of activity or motion within the frame. Audio analysis can similarly be used to detect speech, music, or significant sound events like cheering or alarms. This content-derived feature vector transforms a simple media file into an intelligent data object, enabling a far more sophisticated curation process.

### The Automated Curation Process

The core technical contribution of the invention is the automated curation process that transforms the ingested raw, disparate content items into a cohesive, unified multimedia output. This process is executed by the automated curation engine and is driven by the application of one or more programmatic selection rules. These rules provide a flexible, scalable, and powerful framework for automatically generating compelling multimedia compositions that would be impractical or impossible to create through manual editing, especially in real-time scenarios.

### Programmatic Selection Rules: the Engine of Curation

The programmatic selection rules are configurable instructions that direct the curation engine to identify a target subset of content items from the larger pool of ingested media. These rules can be simple or complex and can be based on a variety of parameters. A key parameter is a spatial attribute. A rule can be configured to select only content items that were captured within a specific, predefined geographic area, such as a geofence around a concert venue, a sports stadium, or an incident location. For example, in a preferred embodiment implemented as a social media application, features described under names such as “Splace,” “Neighbors,” or “Hood” serve as user-facing instantiations of a spatial selection rule. When a user interacts with the “Splace” for a specific tourist site, the system applies a spatial rule to select and display only content items whose spatial metadata falls within the geographic boundaries of that site. Similarly, a rule can be based on a geoline, selecting content that follows a specific path, such as a parade route or a user's travel itinerary as captured in a feature like “My Maps.”

Another critical parameter for the selection rules is a temporal attribute. This allows the system to filter content based on time, which is essential for creating relevant compositions. A programmatic rule can define a time-limited capture window and can be configured to operate in different modes. For instance, a feature described in one embodiment as “ClickClock” represents a synchronized capture mode. In this mode, the system broadcasts a trigger signal, such as a visible countdown timer on user devices, to instruct multiple participating devices to initiate capture simultaneously. This ensures that all resulting footage is perfectly time-aligned to the same moment, which is invaluable for creating multi-angle views of a specific action. In contrast, a feature described as “United” represents an asynchronous capture mode. Here, the rule defines a broader time window (e.g., the two-hour duration of a concert), and any content item whose temporal stamp falls within this window is considered eligible for selection by the curation engine. Furthermore, a feature described as “Quicker” is an example of a rule that not only defines a capture window but also imposes a duration limit on the final composition, such as one minute, to create short, impactful, single-scene clips.

The selection rules can be made even more intelligent by leveraging the semantic attributes derived from the content-derived feature vector. This allows the curation to be based on what is in the video, not just where and when it was shot. For example, a rule for a wedding video could be configured to select clips that have a designated focal point (e.g., automatically identifying and prioritizing clips where the bride or groom is centered in the frame), a specified quantity of detected persons (e.g., prioritizing wide shots with many guests for an establishing scene), or a detected level of user activity (e.g., prioritizing clips with high audio levels and motion during the dancing at the reception). Other rule parameters can include technical capture parameters such as a specific field of view (e.g., selecting only wide-angle shots), aspect ratio, or resolution.

These programmatic rules can be triggered in various ways. They can be pre-configured for an event, defined by a user, or triggered dynamically by external data. In some embodiments, the system provides for real-time media acquisition by allowing one user to trigger a rule that alerts other users based on location or other parameters to capture images or video in real-time. This can be implemented as a collaborative photography request, where a user can solicit other individuals to capture live photos at a designated location, either for free or for a fee. This is particularly useful in applications like journalism or business intelligence, where a news organization or a company can request footage of a specific event or location from users on the ground. The resulting media can then be immediately transmitted and displayed to the requestor. Such requests may be for a particular scene or angle, and may include a bidding model where users can offer compensation to incentivize capture. In further embodiments, these requests can be directed toward businesses, who can in turn engage users to capture scenes featuring their products in specific locations, facilitating crowd-sourced marketing and promotional activities.

In a particularly important application for coordinated event response, a programmatic selection rule may be configured to activate in response to a distress alert initiated by a first user device. For example, in an embodiment described as a “Criminal Event Map,” an alert initiated by a user can trigger a programmatic rule that automatically broadcasts a notification to a plurality of second user devices located within a predefined geographical radius, and activates real-time multimedia recording on the first user's device. The system then ingests the incoming streams from the first user and any responding second users, and the curation engine applies a rule to select and compile the most relevant feeds. An interface may then be provided to a designated Event Manager (e.g., a law enforcement officer or emergency dispatcher) to view multiple content items from the target subset simultaneously, providing comprehensive situational awareness to manage the response effectively.

### Algorithmic Alignment, Composition, and Storage

Once the programmatic selection rule has identified the target subset of content items, the system proceeds to the next phase of the process. An alignment module algorithmically determines the precise spatial and temporal alignment for all items in the subset. This is more sophisticated than simple timestamp matching. This process may include applying a machine learning algorithm to detect and correct for subtle misalignments, using computer vision to analyze pixel-level motion and audio analysis to match ambient sound signatures between streams, thereby ensuring a seamless and professional-quality synchronization.

With the target subset selected and aligned, the system composes the single, unified multimedia output by compiling and rendering the content. The specific arrangement of the content items within the final composition is dictated by a specified ordering logic. This logic can be a simple sequential concatenation, a random selection to create a dynamic montage, or a more complex arrangement based on a defined timeline or geoline. For example, a feature described as “Clipper” in one embodiment provides a powerful instantiation of this logic, allowing for the creation of sophisticated, multi-scene videos where the ordering of clips can be chronologically arranged to tell a story or custom-edited by a user. The final rendered output may also include an attribution layer that programmatically credits the source device or user for each content item. The system is designed for flexibility; all original ingested content items and their associated metadata are stored in a storage subsystem. This allows the same pool of raw content to be reprocessed at a later time using a different set of programmatic selection rules, enabling the creation of entirely new and different compositions from the same event.

### Collaborative Digital Asset (NFT) Generation and Programmatic Ownership Distribution

Building upon the automated curation process, the invention introduces a novel method for generating and distributing ownership of the resulting collaborative work as a verifiable digital asset. This provides a transparent and equitable solution to the complex challenge of managing intellectual property in a many-to-one collaborative environment. After the automated curation engine has generated a composite multimedia video, the system initiates a process to mint a non-fungible token (NFT). This NFT is cryptographically linked to the composite video, serving as a unique, immutable, and verifiable record of ownership on a distributed ledger or blockchain.

A key inventive step of this process is the programmatic distribution of ownership shares of the NFT directly to the digital wallets of each user who contributed a multimedia content item that was included in the final composite video. This is not a manual process but an automated one, executed by a smart contract. The logic for this distribution is configurable. The ownership shares can be determined by a function such as an equal distribution among all contributing users, or a more nuanced distribution proportional to the percentage of time each user's content is featured in the final edited video. This creates a direct and transparent incentive for high-quality contributions.

In a particularly novel embodiment, the system extends this ownership model beyond just the creators. The system can apply a facial recognition algorithm to the composite multimedia video to identify one or more individuals who are the subjects depicted therein. The smart contract logic can then programmatically allocate a percentage of ownership in the NFT to the digital wallets of these identified individuals. This creates a revolutionary and equitable ecosystem where not only the photographers are rewarded, but also the people who are the subjects of the creative work. For example, in an embodiment described as the “Arc Angle” marketplace, where proceeds from a video sale are distributed to the creator and “tagged participants,” the system can use the facial recognition feature of its tagging module to identify these participants and automatically execute the allocation of NFT ownership shares to them.

To create a complete and functional ecosystem, the system may further provide a marketplace interface configured to facilitate transactions involving the NFT, including its sale, auction, or the granting of licenses. The marketplace can include features like bidding systems and user reputation tracking to foster a trusted environment. Furthermore, to ensure maximum inclusivity and fairness, a smart contract associated with the NFT can be configured to enable a retroactive claim of an ownership share by a contributor or subject who did not possess a digital wallet at the time of the initial distribution. This allows participants to join the ecosystem and claim their rightful ownership at any time.

### System Modules and Specific Social Media Embodiments

In a preferred embodiment, the system is implemented as a comprehensive software application, such as a social media application, that leverages the core methods of automated curation and digital asset management to provide a rich, interactive user experience. To support this, the system comprises a plurality of interconnected software modules configured to execute specific functionalities. A registration and authentication module manages user accounts. The registration process may involve a user creating an account with login credentials, such as a username and password. The authentication process may be robust, configured to verify not only login credentials but also official identification documents and a user's cellular phone number to ensure a secure and trusted environment for all interactions, especially those involving transactions or sensitive data. An authorization module may further control access levels based on user login credentials, differentiating between various account types such as registered or subscribed users.

In some embodiments, the system includes a comprehensive user engagement tracking and analytics framework. This may comprise a user engagement tracking module for monitoring metrics such as usage duration, feature interaction, and even facial expression recognition via a device's front-facing camera to gauge user sentiment. An analytics data collection module gathers this user data, along with interaction patterns and app performance metrics. This data is then processed by an analytics data analysis module to extract insights concerning user behavior, which can be used to refine the user experience, improve the performance of programmatic selection rules, and enhance content recommendations.

In further embodiments, the system includes a camera control and synchronization module. This module can be configured to receive signals from cameras integrated with the platform, and may utilize facial recognition or location-based signals to identify a specific user of interest. Upon positive identification, the module can automatically trigger one or more cameras to begin capturing footage of that user. This enables sophisticated applications such as the creation of personalized “reality shows,” where the system programmatically synchronizes and merges captured video segments of a user from multiple locations and timeframes into a single cohesive video output. This allows for the creation of immersive and interactive experiences by combining user-generated footage with pre-edited content, built-in templates, and contributions from other users who may be prompted by the system to film the subject.

In other embodiments, the system includes a location-based communication module. This module provides a chat feature that allows for interactions based on geographic proximity. This is a direct implementation of a programmatic rule where the right to participate in a communication channel is governed by a spatial attribute. Users can engage in chat communications within specific location-based ranges, such as a single building, a park, or a tourist site (an embodiment referred to as a “Splace”). The system may also allow users to seamlessly switch between different chat spaces as their location changes, as seen in a “SpacePlace” feature that aggregates chats from various locations a user has visited. This functionality is deeply integrated with the spatial rules of the curation engine, creating a contextual communication layer that enhances collaborative creation and community engagement.

In some embodiments, the system provides a robust marketplace and monetization framework. A bidding and selling module enables the sale of media based on location and time through a bidding process within a content archiving module. This archive, which may be referred to as an “Arc Angle,” stores all user-contributed content and allows it to be searched and retrieved based on spatial and temporal parameters. This creates a vibrant marketplace where photographers can be compensated for their work and where third parties, such as news agencies or marketing firms, can procure specific, on-demand content. This is further enhanced by an optional “control room” editing interface, where a purchaser can view simultaneous streams from various angles and select preferred footage to include in a final composition. Media sharing options are flexible, allowing content to be stored in a private or shared archive, or distributed directly to all contributing photographers for their personal use.

In further embodiments, the system's editing capabilities are extensive and versatile. In addition to the fully automated curation process, the system may provide users with tools for professional-level manual or hybrid editing. Users may generate media from different angles by capturing footage for a single scene within a defined timeframe (an embodiment referred to as “Quicker”) or create complex, multi-scene compositions without time limitations by combining multiple clips (an embodiment referred to as “Clipper”). These tools provide users with the capability to generate both simple automated videos and more complex professional-quality videos, optionally enhanced by machine learning algorithms that suggest optimal editing sequences or styles based on user preferences or content analysis. The final output, whether generated automatically or manually edited, can be exported in multiple formats suitable for a wide range of platforms.

In other embodiments, the social media platform can be further enriched with numerous features that leverage the core curation and location-aware technologies. The platform may include a “Personal Area” screen serving as a user's central hub, which can include a “My Maps” feature to visualize travel routes augmented with geo-tagged photos from both the user and others. A “Prime” feature can act as a personal curation agent, automatically generating weekly or monthly summary videos of a user's activities. To drive engagement, the platform can incorporate gamification elements, such as rating and scoring systems that reward users for participation as content creators or subjects. The system can also facilitate social connections by providing a “Friend Suggestions” feature that recommends users based on shared locations or interests, and a “My Story” feature for sharing narrative content about personal connections. The platform may support a wide variety of location-based services and interactions, including an “Invite” screen for proposing local activities, a “Second Hand” or “Homes” marketplace for local goods and real estate, and information services like “How's It There?” which provides live or recent footage from venues like bars and clubs. All of these features are powered by the system's underlying ability to programmatically select, filter, and present content based on spatial and temporal rules.

### Additional Embodiments

The core method of automated curation is a versatile platform technology that can be specifically configured for numerous industries, providing high-value solutions for each.

In a further embodiment, the principles of the present disclosure are applied to a system and method for facilitating a coordinated response to real-time events, such as emergencies. The system is implemented as a map-based platform, accessible via a software application on user computing devices, such as smartphones or tablets. An “initiating user” can trigger a distress alert through the application, which then automatically transmits as a notification to a plurality of “responder” users who are physically located within a predetermined or dynamically configured geographical radius of the initiating user. Upon initiation of the alert, the system is configured to automatically activate the camera and microphone of the initiating user's device, thereby commencing the recording of an audio-video stream of the unfolding event. This real-time stream constitutes one of the multimedia content items that can be transmitted to the system's server and simultaneously broadcast to the responders within the defined radius. Responders who receive the alert are thereby enabled to understand that an incident is occurring, view its location on a map, and optionally approach the location to provide assistance. Furthermore, responders can utilize their own mobile devices to record the event from their unique perspectives, contributing additional multimedia content items, including video and audio streams, to the system. This collection of content from the initiator and multiple responders forms the basis for the synchronized, multi-angle composition central to the present invention. Contemporaneously with the broadcast of the alert, a request for event management is transmitted to a designated “Event Manager.” The Event Manager may be designated based on a predefined hierarchy, such as rank, qualification, or proximity to the event. The system grants the Event Manager privileged access to a control interface, allowing them to communicate with all responders who have acknowledged the distress call. The Event Manager is capable of accessing and viewing all real-time video streams being captured by the initiating user and the various responders. The interface allows the Event Manager to switch between these video feeds, providing multiple angles and comprehensive situational awareness of the event, consistent with the multi-angle perspective generation described herein. All captured audio-video streams and their associated composite contextual metadata are securely recorded and stored in a server-side repository or a folder specific to the incident for post-event investigation, analysis, and evidence collection. To expand visual coverage, the system is further configured to identify and solicit media from other camera sources in the event's vicinity, including interfacing with existing fixed security cameras or broadcasting requests to nearby vehicles to obtain dash camera footage.

In other embodiments, the system is deployed for the Insurance Industry, where it serves as a powerful tool for automated insurance claim verification and fraud reduction. Following an event such as a traffic accident or property damage, a programmatic selection rule can be configured to gather and compile all relevant multimedia content items. For a vehicle collision, for example, the rule would ingest footage from the dash cameras of the involved vehicles, supplemented by content from nearby security cameras, traffic cameras, and even mobile phone footage uploaded by witnesses at the scene. The automated curation process then aligns and composes this multi-perspective evidence into a single, cohesive timeline of the event. The system then compares the curated composition with predefined event data associated with the insurance claim, such as the reported time, location, weather conditions, and the narrative of the accident. By algorithmically cross-referencing the verified, multi-angle visual record with the claim details, the system can automatically flag inconsistencies, assess liability more accurately, and verify the legitimacy of the claim, thereby significantly expediting processing for valid claims and reducing fraudulent payouts.

In further embodiments, the method is applied within the Healthcare and Medical fields for medical procedure documentation, training, and real-time remote consultation. The system can be configured to automatically compile and precisely align multimedia content captured from various specialized medical devices during a complex surgical procedure. These devices may include endoscopic cameras providing an internal view, fixed overhead cameras capturing the overall operating theater, and wearable cameras worn on a surgeon's headset providing a first-person perspective. The automated curation engine applies a programmatic rule to synchronize these disparate feeds with sub-second accuracy, creating a unified and perfectly aligned record of the entire procedure. This composite video is invaluable for post-procedure review, quality assurance, and for creating detailed training materials for medical students and residents. Moreover, this unified output can be securely streamed in real-time, enabling a specialist in a different geographic location to provide remote professional review and expert guidance during a critical phase of an operation, effectively democratizing access to specialized medical expertise and improving patient outcomes.

Finally, in a Social Media and Entertainment context, the extensive feature set described in the original disclosure can be understood as user-facing embodiments of the underlying programmatic rules. Features like “Roadshow” (compiling dash cam footage), “Invite” (triggering content creation based on a spatial-social rule), “Tripz” (compiling a travelogue along a geoline), and the virtual property game “Monopoli” (linking digital asset value to the quantity and engagement of content generated at a specific spatial location) all represent specific, creative applications of the core inventive process of automated curation based on programmatic rules. The “location-based chat” feature further enhances these embodiments by providing a communication layer that is contextually tied to the same spatial and temporal rules governing the content curation, fostering a deeply integrated and collaborative user experience.

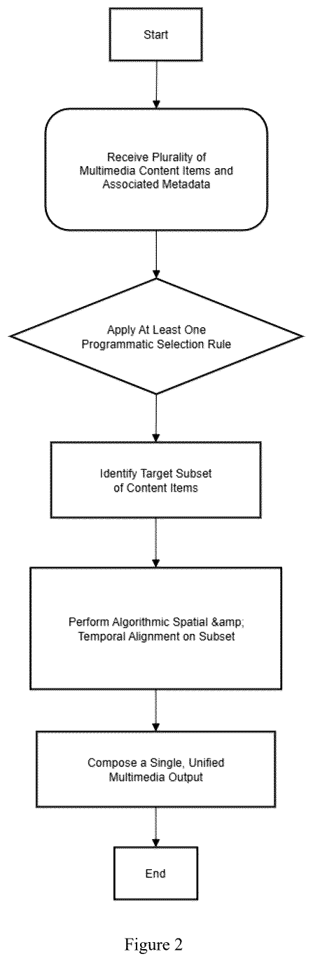

Further details of the system's operation and specific embodiments are illustrated in the remaining figures. FIG. 2 provides a conceptual diagram illustrating the generation of the composite contextual metadata record for each multimedia content item, in accordance with an embodiment of the present disclosure. As shown, a multimedia content item, such as a video clip from a device, is processed to extract key data points. These include fundamental metadata like the spatial coordinates (e.g., GPS data) and a temporal stamp. Additionally, the diagram illustrates the application of an analysis engine, such as a machine learning model, to the content itself to generate a content-derived feature vector. This vector may contain semantic attributes such as identified objects, facial recognition data, or activity level metrics, which are then appended to the metadata record, creating a rich data object ready for the automated curation process.

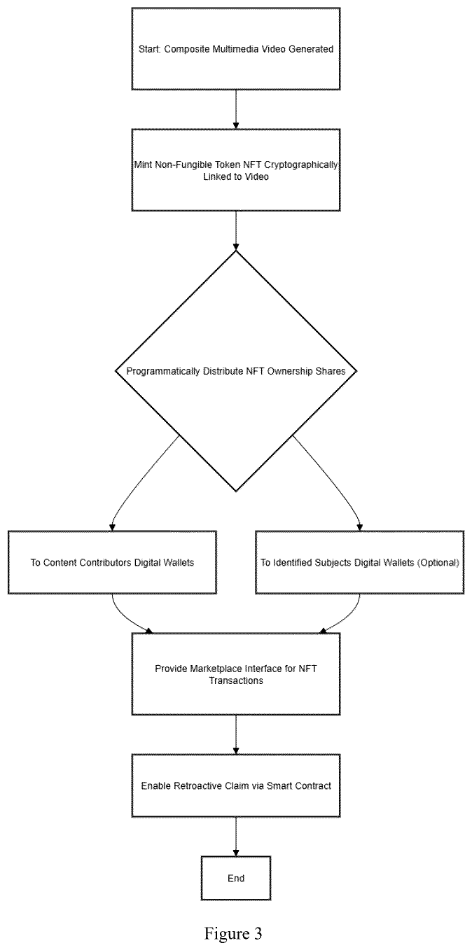

The novel method for managing ownership of collaborative works is illustrated in the flowchart of FIG. 3, in accordance with an embodiment of the present disclosure. This process is initiated after a composite multimedia video has been generated. The first step is to mint a non-fungible token (NFT) that is cryptographically linked to the composite video, establishing a verifiable record of the asset on a blockchain. The key inventive step, shown next, is the programmatic distribution of ownership shares of this NFT. The system automatically transfers these shares to the digital wallets of the contributors and, in some embodiments, the subjects depicted in the video. The process also includes providing a marketplace interface to facilitate transactions and enabling a retroactive claim mechanism via a smart contract, ensuring a complete and equitable digital asset management lifecycle.

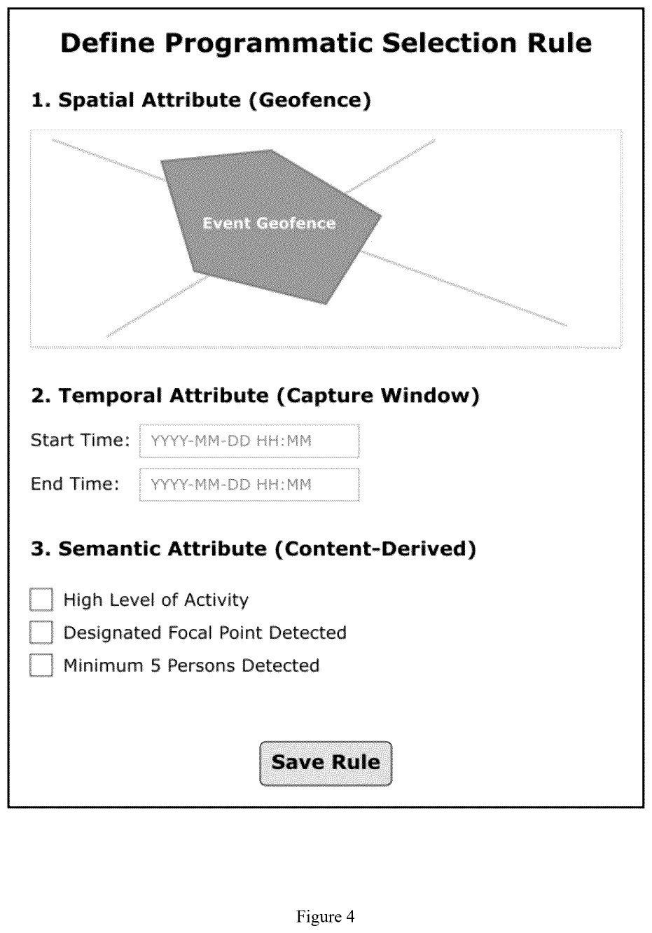

FIG. 4 illustrates a user interface embodiment that enables the configuration of the programmatic selection rules, in accordance with an embodiment of the present disclosure. As shown on the screen, a user or system administrator can define parameters for the automated curation process. These parameters may include defining a spatial attribute by drawing a geofence on a map, setting a temporal attribute by specifying a start and end time for a capture window, and selecting semantic attributes, such as requesting content that features a “high level of activity” or a specific “designated focal point.” This interface demonstrates how the abstract concept of programmatic rules can be implemented in a practical, user-friendly manner, allowing for the dynamic creation of custom curation logic for any event or purpose.

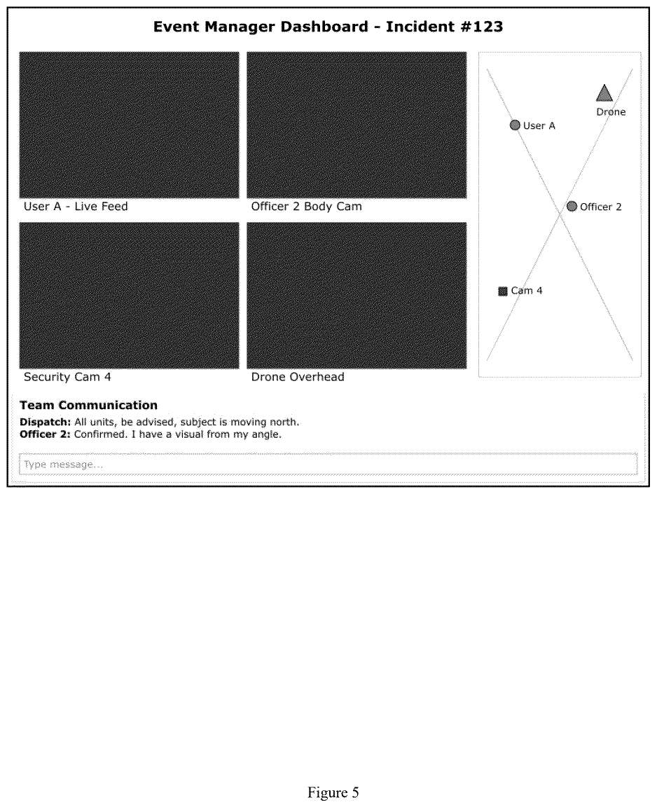

An exemplary interface for an Event Manager in a coordinated response scenario is depicted in FIG. 5, in accordance with an embodiment of the present disclosure. This interface provides the manager with a real-time, multi-angle view of an incident by displaying multiple, synchronized content streams that have been selected by the automated curation process in response to a distress alert. The Event Manager can switch between different camera views, view a map showing the location of each active device, and communicate with responders. This figure provides a concrete example of how the automated curation process can be applied to enhance situational awareness and decision-making in critical, real-time applications such as emergency response and security monitoring.

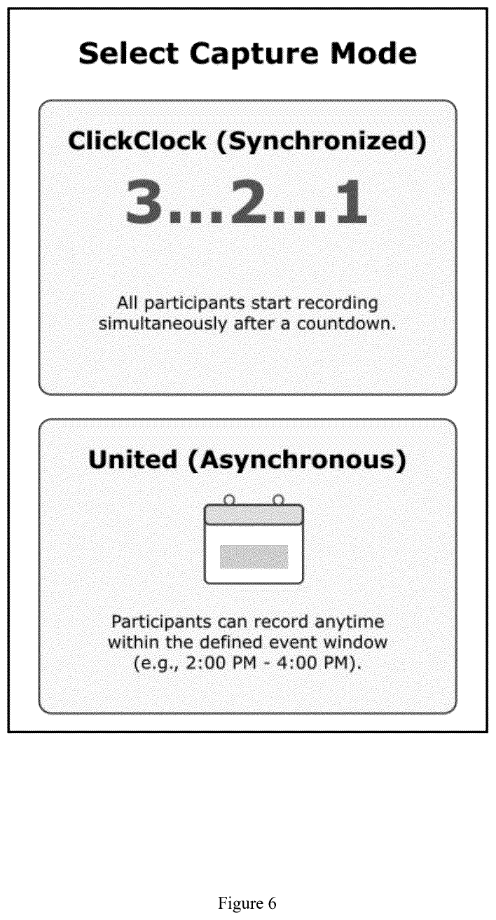

FIG. 6 shows an exemplary user interface screen, referred to as the “Angle” screen, which illustrates the implementation of different temporal capture modes, in accordance with an embodiment of the present disclosure. The interface allows a user to select between a “ClickClock” mode, which represents a synchronized capture mode where a countdown timer coordinates a simultaneous start for all participating devices, and a “United” mode, which represents an asynchronous capture mode where participants can capture content at any time within a broader, predefined window. This figure provides a clear example of how the temporal attribute of a programmatic selection rule can be implemented to facilitate different styles of collaborative content creation.

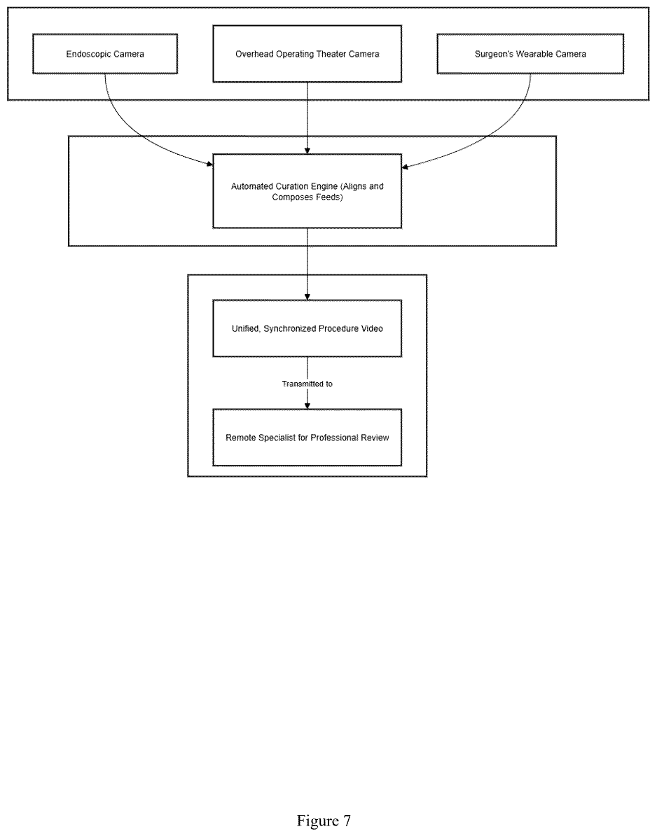

The application of the invention within the healthcare sector is illustrated in FIG. 7, in accordance with an embodiment of the present disclosure. This diagram shows a surgical environment where content is being captured by multiple medical devices, including an endoscope, a fixed overhead camera, and a wearable camera on a surgeon. The system receives these streams and applies a programmatic rule to align and compose them into a unified output. This output is then transmitted for remote professional review by a specialist, who can view the synchronized, multi-angle procedure in real-time. This figure demonstrates a high-value embodiment for medical procedure documentation, training, and remote consultation.

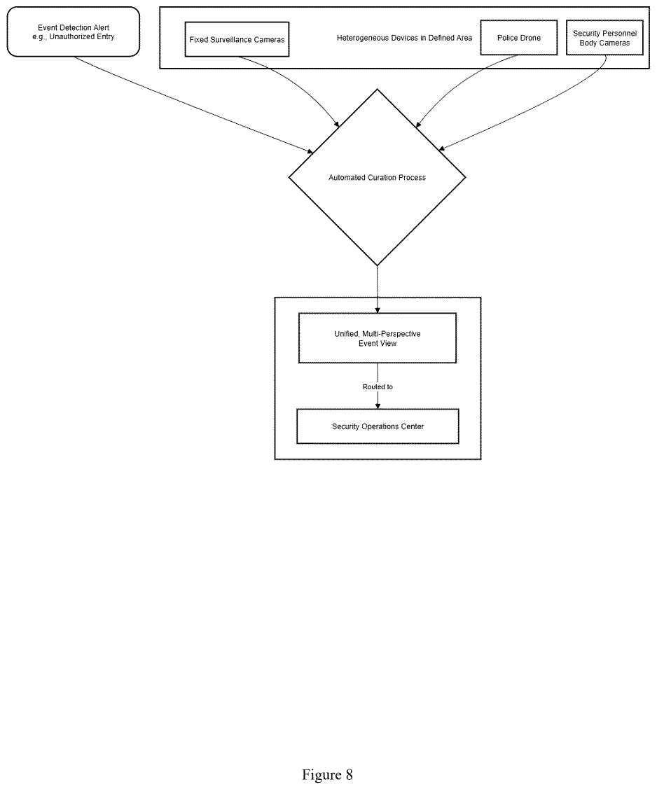

FIG. 8 depicts an embodiment for security monitoring and emergency response, in accordance with an embodiment of the present disclosure. It illustrates a defined area, such as a public square or critical infrastructure site, being monitored by a heterogeneous set of devices, including fixed surveillance cameras, a police drone, and body cameras worn by security personnel. In response to a real-time event detection alert, such as an unauthorized entry, the system's automated curation process is triggered. A programmatic rule selects and compiles the relevant feeds, creating a unified, multi-perspective view of the event that can be immediately routed to a security operations center, enabling a faster and more informed response.

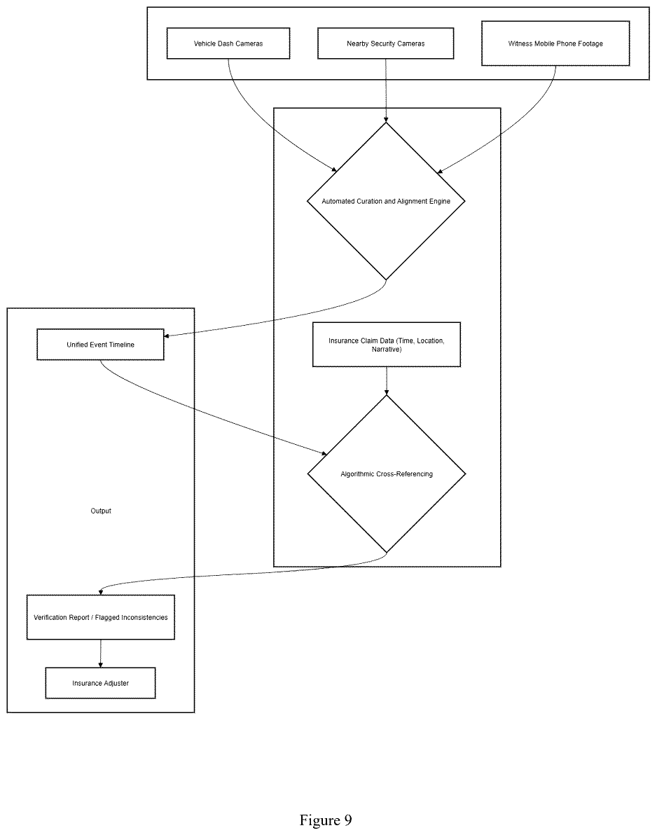

FIG. 9 depicts an embodiment for the insurance industry, illustrating how the system facilitates automated insurance claim verification, in accordance with an embodiment of the present disclosure. The diagram shows a scenario, such as a traffic collision, where a plurality of multimedia content items are captured by a heterogeneous set of devices, including dash cameras from involved vehicles, fixed traffic or security cameras, and footage provided by witnesses on mobile devices. Following an event that may lead to an insurance claim, the system's automated curation process is initiated. A programmatic selection rule, configured with the spatial and temporal parameters of the incident, is applied to ingest and compile all relevant footage. The system composes a unified, multi-perspective reconstruction of the event, which can then be algorithmically cross-referenced with the details of an insurance claim to verify its accuracy, expedite processing, and reduce fraudulent activity.

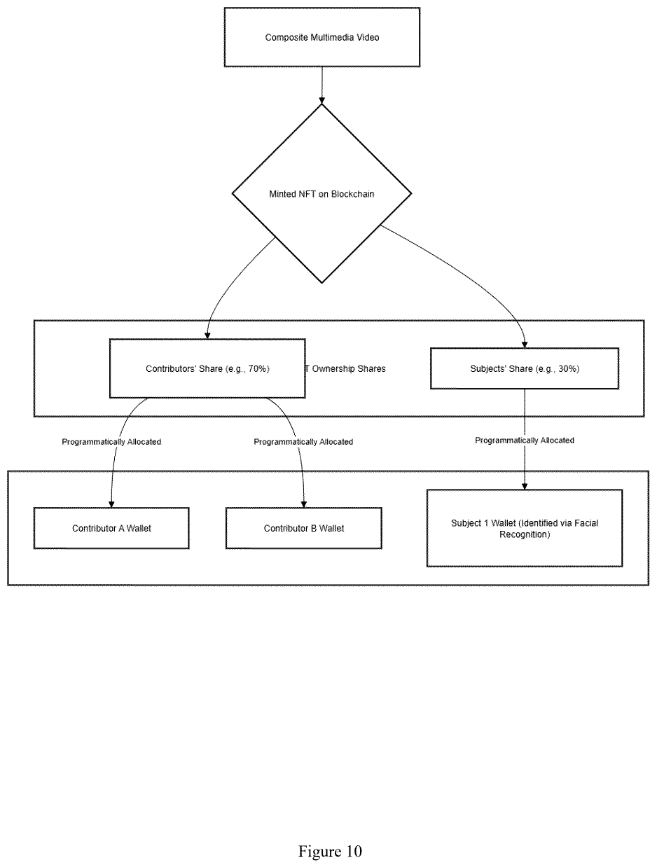

FIG. 10 illustrates a conceptual diagram of the NFT ownership distribution process, in accordance with an embodiment of the present disclosure. The diagram shows a composite multimedia video at the center, from which an NFT is minted. Arrows point from the video to icons representing the different participants in its creation: “Contributors,” who provided the source video clips, and “Subjects,” who were identified within the video via facial recognition. Further arrows show the programmatic allocation and transfer of NFT ownership shares from these participant pools to their respective digital wallets. This figure visually represents the novel and equitable ownership model enabled by the invention, where all key participants in a collaborative work are automatically rewarded.

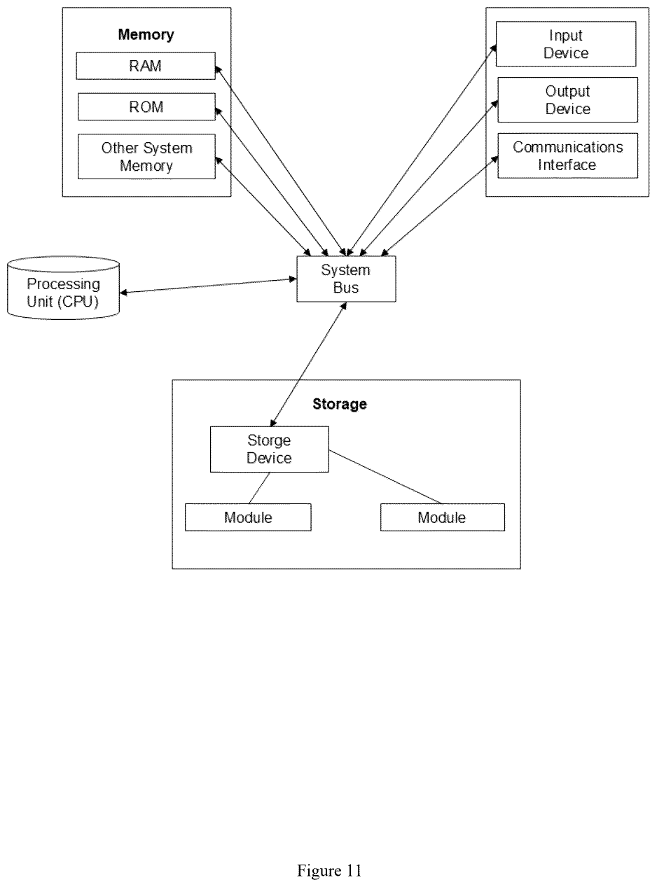

FIG. 11 depicts an exemplary system, in accordance with an embodiment of the present disclosure, including a general-purpose computing device, including a processing unit (e.g., CPU) and a system bus that couples various system components including the system memory such as read only memory (ROM) and random-access memory (RAM) to the processing unit. Other system memory may be available for use as well. It can be appreciated that the system in the present disclosure may operate on a computing device with more than one processing unit or on a group or cluster of computing devices networked together to provide greater processing capability. Processing unit can include a general-purpose CPU controlled by software as well as a special-purpose processor. The computing device further includes one or more storage devices. The storage device may be connected to the system bus by a drive interface. The drives and the associated computer readable media provide nonvolatile storage of computer readable instructions, data structures, program modules and other data for the computing device. In one aspect, a hardware module that performs a particular function includes the software component stored in a tangible computer-readable medium in connection with the necessary hardware components, such as the CPU, bus, display, and so forth, to carry out the function. To enable user interaction with the computing device, an input device represents any number of input mechanisms, such as a mobile phone, a security camera, and so forth. The output device can also be one or more of several output mechanisms known to those of skill in the art. The communications interface generally governs and manages the user input and system output. Operations described in the present disclosure can be implemented as modules configured to control the processor to perform particular functions according to the programming of the module. FIG. 11 also illustrates exemplary modules, which are representative software modules controlling the processor to perform particular steps or a series of steps as described herein. These modules may be stored on the storage device and loaded into RAM or memory at runtime.

1. A method of generating a multimedia composition, the method comprising:
a. receiving a plurality of multimedia content items from a heterogeneous set of independently operating devices;
b. for each of the plurality of multimedia content items, generating a composite contextual metadata record, said record comprising at least spatial coordinates and a temporal stamp;
c. executing an automated curation process on the plurality of content items and their associated composite contextual metadata records, said process comprising:
i. applying at least one programmatic selection rule to identify a target subset of the content items, wherein said rule is based on parameters selected from the group consisting of a spatial attribute, a temporal attribute, and a capture parameter; and
ii. algorithmically determining a spatial and temporal alignment for the identified target subset; and
iii. composing a single, unified multimedia output by compiling and rendering the aligned target subset according to the applied programmatic selection rule.

2. The method of claim 1, wherein the composite contextual metadata record further comprises a content-derived feature vector, and wherein the programmatic selection rule is further based on a semantic attribute specified in the content-derived feature vector.

3. The method of claim 2, wherein the semantic attribute comprises a designated focal point, a specified quantity of detected objects or persons, or a detected level of user activity, and wherein the capture parameter is selected from the group consisting of a field of view and an aspect ratio.

4. The method of claim 1, wherein the heterogeneous set of independently operating devices includes at least one user-operated mobile device and at least one automated device selected from the group consisting of a security camera, a dash camera, and a wearable camera.

5. The method of claim 1, wherein the temporal attribute of the programmatic selection rule defines a time-limited capture window, and wherein the curation process is configured to operate in at least one of two modes: a synchronized mode wherein capture is initiated simultaneously via a trigger signal, or an asynchronous mode wherein content items captured at any point within the window are eligible for selection; and wherein the programmatic selection rule is further defined by a specified ordering logic comprising a sequential concatenation, a random selection, or an arrangement based on a defined timeline or geoline.

6. The method of claim 1, wherein the programmatic selection rule is configured to identify and compile content in response to a distress alert initiated by a first user device, the method further comprising providing an interface for a designated Event Manager to view multiple content items from the target subset simultaneously.

7. The method of claim 1, further comprising applying a machine learning algorithm to detect and correct for misalignment in the identified target subset.

8. The method of claim 1, further comprising storing the composite contextual metadata records and the multimedia content items in a storage subsystem for subsequent reprocessing using a different programmatic selection rule.

9. A method for generating and distributing ownership of a digital asset representing a collaborative work, the method comprising:
a. generating a composite multimedia video by receiving a plurality of multimedia content items from a heterogeneous set of devices, generating a composite contextual metadata record for each item, and executing an automated curation process to compose a unified multimedia output based on a programmatic selection rule;
b. minting, by at least one processor, a non-fungible token (NFT) cryptographically linked to the composite multimedia video, said NFT representing a verifiable record of ownership; and
c. programmatically distributing, by the at least one processor, ownership shares of the NFT to a digital wallet of each user who contributed a multimedia content item that was included in the composite multimedia video.

10. The method of claim 9, wherein the distribution of ownership shares is determined by a configurable function selected from the group consisting of an equal distribution among all contributing users and a distribution proportional to a percentage of time each user's content item is used in the composite multimedia video.

11. The method of claim 9, further comprising:
a. applying a facial recognition algorithm to the composite multimedia video to identify one or more individuals depicted therein; and
b. programmatically allocating a percentage of ownership in the NFT to a digital wallet of at least one of the identified individuals.

12. The method of claim 9, further comprising providing a marketplace interface configured to facilitate a transaction involving the NFT, said transaction comprising at least one of a sale, an auction, or a license grant.

13. The method of claim 9, further comprising enabling, via a smart contract associated with the NFT, a retroactive claim of an ownership share by a contributing user who did not possess a digital wallet at the time of the distribution.

14. A system for generating a multimedia composition, the system comprising:
a. at least one processor; and
b. a non-transitory computer-readable storage medium storing instructions that, when executed by the at least one processor, cause the system to perform operations comprising:
i. receiving a plurality of multimedia content items from a heterogeneous set of independently operating devices;
ii. for each of the plurality of multimedia content items, generating a composite contextual metadata record, said record comprising at least spatial coordinates and a temporal stamp; and
iii. executing an automated curation process on the plurality of content items and their associated composite contextual metadata records by:
1) applying at least one programmatic selection rule to identify a target subset of the content items, wherein said rule is based on parameters selected from the group consisting of a spatial attribute, a temporal attribute, and a capture parameter;
2) algorithmically determining a spatial and temporal alignment for the identified target subset; and
3) composing a single, unified multimedia output by compiling and rendering the aligned target subset according to the applied programmatic selection rule.

15. The system of claim 14, wherein the composite contextual metadata record further comprises a content-derived feature vector, and wherein the programmatic selection rule is further based on a semantic attribute specified in the content-derived feature vector, said semantic attribute comprising a designated focal point, a specified quantity of detected objects or persons, or a detected level of user activity.

16. The system of claim 14, wherein the programmatic selection rule is configured to identify and compile content in response to a distress alert initiated by a first user device, and wherein the operations further comprise providing an interface for a designated Event Manager to view multiple content items from the target subset simultaneously.

17. The system of claim 14, wherein the programmatic selection rule is further defined by a specified ordering logic comprising a sequential concatenation, a random selection, or an arrangement based on a defined timeline or geoline.

18. The system of claim 14, wherein the operations further comprise minting a non-fungible token (NFT) cryptographically linked to the unified multimedia output and programmatically distributing ownership shares of the NFT.

19. The system of claim 18, wherein the operations further comprise applying a facial recognition algorithm to the unified multimedia output to identify one or more individuals depicted therein, and programmatically allocating a percentage of ownership in the NFT to a digital wallet of at least one of the identified individuals.

20. A non-transitory computer-readable storage medium storing instructions that, when executed by at least one processor of a computing device, cause the computing device to perform the method of claim 1.
